(19) United States
(12) Patent Application Publication
(10) Pub. No.: US 2013/0152664 A1
(43) Pub. Date: Jun. 20, 2013

(54) CIRCUIT FOR CORRECTING PHASE ERROR OF GYRO SENSOR, GYRO SENSOR SYSTEM AND METHOD FOR CORRECTING PHASE ERROR OF GYRO SENSOR

(71) Applicant: Samsung Electro-Mechanics Co., Ltd., Gyeonggi-do (KR)

(72) Inventor: Seung Chul Pyo, Gyeonggi-do (KR)

(73) Assignee: SAMSUNG ELECTRO-MECHANICS CO., LTD., Gyeonggi-do (KR)

(21) Appl. No.: 13/714,078

(22) Filed: Dec. 13, 2012

(30) Foreign Application Priority Data
Dec. 20, 2011 (KR) 10-2011-0138399

(51) Int. Cl. G01P 21/00

(52) U.S. Cl. CPC G01P 21/00
USPC 73/1.38

(57) ABSTRACT

The present invention relates to a circuit for correcting a phase error of a gyro sensor, a gyro sensor system and a method for correcting a phase error of a gyro sensor. In accordance with one embodiment of the present invention, the circuit for correcting a phase error of a gyro sensor includes: an offset detecting unit for detecting an offset due to the phase error included in a gyro output signal outputted by being demodulated from an output of the gyro sensor; a variable frequency generating unit for generating a switching frequency varied according to the result detected in the offset detecting unit; and a switched capacitor switched according to the switching frequency generated in the variable frequency generating unit. And also, a gyro sensor system including the circuit and a method for correcting a phase error of a gyro sensor are proposed.

### CROSS-REFERENCE TO RELATED APPLICATIONS

This application claims the benefit of Korean Patent Application No. 10-2011-0138399 filed with the Korea Intellectual Property Office on Dec. 20, 2011, the disclosure of which is incorporated herein by reference.

### BACKGROUND OF THE INVENTION

1. Field of the Invention

The present invention relates to a circuit for correcting a phase error of a gyro sensor, a gyro sensor system and a method for correcting a phase error of a gyro sensor. Particularly, the present invention relates to a circuit for correcting a phase error of a gyro sensor, a gyro sensor system and a method for correcting a phase error of a gyro sensor capable of generating a phase error corrected signal using a switched capacitor to apply as a demodulation signal.

2. Description of the Related Art

As a gyro sensor is a sensor to detect an angular velocity, it has been widely used in an attitude control of an aircraft, a robot and the like, a handshake correction of a camera, binoculars and the like, a vehicle sliding and rotating prevention system, a navigation and the like. In recent, the utilization of the gyro sensor is very high by being mounted on a smart phone.

The gyro sensor is classified into various types such as a rotation type, a vibration type, a flow type, an optical type; and, in recent, the vibration type is frequently used in mobile products. The vibration type sensor is largely divided into two types, i.e., one is a piezoelectric type and an electrostatic type. As a vibration type sensor currently used, the electrostatic type having a comb structure occupies mostly, but the piezoelectric type is partially utilized. In general, the vibration type gyro sensor detects the size of angular velocity by Coriolis force.

The sensor output signal of the gyro sensor is outputted with including a driving signal component and a gyro signal component and the driving signal component is greater than the gyro signal component. Therefore, in order to obtain a desired result, it is needed to remove the driving signal component included in the sensor output signal.

At this time, conventionally, by using the component signal applied to the gyro sensor, the driving signal component and the gyro component included in the sensor output signal are separated or the driving signal component is removed.

But, a conventional gyro sensor is manufactured by using a general MEMS (Micro Electro Mechanical Systems) process; and, even if it is very precisely manufactured, there occurs a slight deviation in itself. Accordingly, the phase error due to such deviation may remain in the gyro output signal outputted by being modulated from the sensor output signal.

### SUMMARY OF THE INVENTION

Therefore, there is needed to remove the offset according to the phase error included in the gyro output signal outputted by being modulated from the output of the gyro sensor.

The present invention has been invented in order to overcome the above-described problems and it is, therefore, an object of the present invention to prevent the distortion of offset according to a phase error by generating a phase corrected demodulation signal by detecting the change of a phase error included in a gyro output signal outputted by being modulated from the output of a gyro sensor and applying the generated signal as a demodulation signal for modulating the gyro output signal from the output of the gyro sensor.

In accordance with a first embodiment of the present invention to achieve the object, there is provided a circuit for correcting a phase error of a gyro sensor, including: an offset detecting unit for detecting an offset due to the phase error included in a gyro output signal outputted by being demodulated from an output of the gyro sensor; a variable frequency generating unit for generating a switching frequency varied according to the result detected in the offset detecting unit; and a phase correcting unit including a switched capacitor switched according to the switching frequency generated in the variable frequency generating unit and supplying a gyro sensor driving signal from the output of the gyro sensor as a demodulation signal to demodulate the gyro output signal, wherein the gyro sensor driving signal being supplied as the demodulation signal is corrected in phase according to a signal transmission characteristic of the switched capacitor.

In another example of the present invention, the phase correcting unit includes: the switched capacitor for playing a role of a resistor varied according to the switching frequency, wherein the switched capacitor receives and transmits the gyro sensor driving signal; a ground capacitor connected between an output terminal of the switched capacitor and a ground; and an amplifier for receiving the gyro sensor driving signal, outputting the gyro sensor driving signal corrected in phase according to the value of the ground capacitor and a signal transmission characteristic value of the switched capacitor being varied according to the switching frequency and supplying the gyro sensor driving signal corrected in phase as the demodulation signal.

At this time, a resistor R2 is formed on a path which is fed back from an output terminal of the amplifier to an inverted input terminal of the amplifier, a resistor R1 is connected to the inverted input terminal of the amplifier to receive the gyro sensor driving signal and to the gyro sensor driving signal transmit through the resistor R2, and the switched capacitor and the ground capacitor are connected to a non-inverted input terminal of the amplifier.

And also, in one example, the switched capacitor includes: a first switch for transmitting the gyro sensor driving signal received from an input terminal of the switched capacitor with performing a switching operation; a second switch for outputting the signal received from a first capacitor through an output terminal of the switched capacitor with performing a switching operation; the first capacitor connected between the first switch and the second switch for charging and discharging according to the switching operations of the first and second switches; a third switch connected between a connection node of the first switch and the first capacitor and the ground; and a fourth switch connected between a connection node of the first capacitor and the second switch and the ground.

At this time, in another example, a group of the first and third switches and a group of the second and fourth switches are alternately switched according to the switching frequency; the second and fourth switches are turned off when the first and third switches are turned on; and the second and fourth switches are turned on when the first and third switches are turned off.

Thereafter, in accordance with a second embodiment of the present invention to achieve the object, there is provided a gyro sensor system, including: a gyro sensor for outputting a sensor output signal according to a movement of an object through a sensor electrode by receiving a driving signal; a signal processing unit for receiving the sensor output signal from the gyro sensor, separating a gyro signal component included in the sensor output signal and outputting as a gyro output signal; an offset detecting unit for detecting an offset due to a phase error included in the gyro output signal outputted from the signal processing unit; a variable frequency generating unit for generating a switching frequency varied according to the result detected in the offset detecting unit; and a phase correcting unit for receiving the sensor output signal of the gyro sensor, converting a phase thereof and supplying a gyro sensor driving signal to the gyro sensor by feedback, wherein the phase correcting unit includes a switched capacitor switched according to a switching frequency generated in the variable frequency generating unit and supplies the gyro sensor driving signal corrected the phase thereof according to a signal transmission characteristic of the switched capacitor as a demodulation signal for demodulating the gyro output signal in the signal processing unit.

In another example of the present invention, the phase correcting unit includes: the switched capacitor for playing a role of a resistor varied according to the switching frequency, wherein the gyro sensor driving signal is inputted to and transmitted from the switched capacitor; a ground capacitor connected between an output terminal of the switched capacitor and a ground; and an amplifier for receiving the gyro sensor driving signal, outputting the gyro sensor driving signal corrected in phase according to the value of the ground capacitor and a signal transmission characteristic value of the switched capacitor being varied according to the switching frequency and supplying the gyro sensor driving signal corrected in phase as the demodulation signal.

And also, in another example, the signal processing unit includes: a charge voltage converting unit for receiving the sensor output signal from the gyro sensor to convert into a voltage signal; and an analog signal processing unit for receiving an output signal converted from the charge voltage converting unit, separating a driving signal component and a gyro signal component included therein by using the demodulation signal applied from the phase correcting unit, and outputting the gyro output signal by removing the separated driving signal component.

At this time, according to another example, the analog signal processing unit includes: a demodulator for receiving the output signal of the charge voltage converting unit, and separating the driving signal component and the gyro signal component by using the demodulation signal; and a low pass filter for removing the driving signal component separated from the demodulator.

And also, in one example, the gyro sensor is a piezoelectric type or an electrostatic vibration gyro sensor.

Thereafter, in order to solve the above-described problems, in accordance with a third embodiment of the present invention, there is provided a method for correcting a phase error of a gyro sensor, including: detecting an offset due to a phase error included in a gyro output signal outputted by being demodulated from an output of the gyro sensor; generating a switching frequency varied according to a result detected in detecting the offset; and supplying a gyro sensor driving signal from the output of the gyro sensor as a demodulation signal to demodulate the gyro output signal, wherein the gyro sensor driving signal being supplied as the demodulation signal is corrected in phase according to a signal transmission characteristics of a switched capacitor being switched according to the switching frequency.

In accordance with another example of the present invention, the method for correcting the phase error of the gyro sensor further includes: receiving a driving signal in the gyro sensor and outputting a sensor output signal according to a movement of an object through a sensor electrode; and separating a gyro signal component included in the outputted sensor output signal using the demodulation signal supplied in the step of supplying the gyro sensor driving signal, and outputting the gyro signal component as the gyro output signal, wherein, in detecting the offset, the offset due to the phase error included in the gyro output signal outputted in outputting the gyro signal component is detected.

At this time, in one example, outputting the gyro signal component includes: receiving the sensor output signal of the sensor electrode and converting into a voltage signal; and separating a driving signal component and the gyro signal component included in the output signal converted into voltage signal and outputted using the demodulation signal to remove the separated driving signal component and outputting the gyro signal component as the gyro output signal.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a block diagram schematically showing a gyro sensor system including a circuit for correcting a phase error of a gyro sensor in accordance with one embodiment of the present invention;

FIG. 2 is a circuit diagram schematically showing a phase correcting unit in one example of the circuit for correcting the phase error of the gyro sensor as shown in FIG. 1;

FIG. 3 is a flow chart schematically showing a method for correcting a phase error of a gyro sensor in accordance with one embodiment of the present invention;

FIG. 4 is a flow chart schematically showing a method for correcting a phase error of a gyro sensor in accordance with another embodiment of the present invention; and

FIG. 5 is a flow chart schematically showing a method for correcting a phase error of a gyro sensor in accordance with still another embodiment of the present invention.

### DETAILED DESCRIPTION OF THE PREFERABLE EMBODIMENTS

Hereinafter, exemplary embodiments of the present invention will be described in detail. However, the present invention is not limited to the embodiments disclosed below but can be implemented in various forms. The following embodiments are described in order to enable those of ordinary skill in the art to embody and practice the present invention. To clearly describe the present invention, parts not relating to the description are omitted from the drawings. Like numerals refer to like elements throughout the description of the drawings.

Terms used herein are provided for explaining embodiments of the present invention, not limiting the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated components, motions, and/or devices, but do not preclude the presence or addition of one or more other components, motions, and/or devices thereof.

Prior to the description of the present invention, except that the source of output signal is described, ‘a sensor output signal’ described in the present specification means an output signal of the gyro sensor and ‘a gyro output signal’ means an output signal obtained by modulating a gyro signal component from the output signal of the gyro sensor. And also, except that a place where the driving signal is applied, in case when ‘a driving signal’ or ‘a gyro sensor driving signal’ is merely described, it means a driving signal applied to the gyro sensor; and, in case when it is applied to separate ‘a gyro output signal’ from an output signal of the gyro sensor as ‘a phase corrected driving signal’ or ‘a driving signal’, it mean a demodulation signal.

At first, a circuit for correcting a phase error of a gyro sensor in accordance with a first embodiment of the present invention will be described in detail with reference to the drawings. At this time, reference numerals not shown in the drawings may be the reference numerals to represent the same constructions shown in the other drawings.

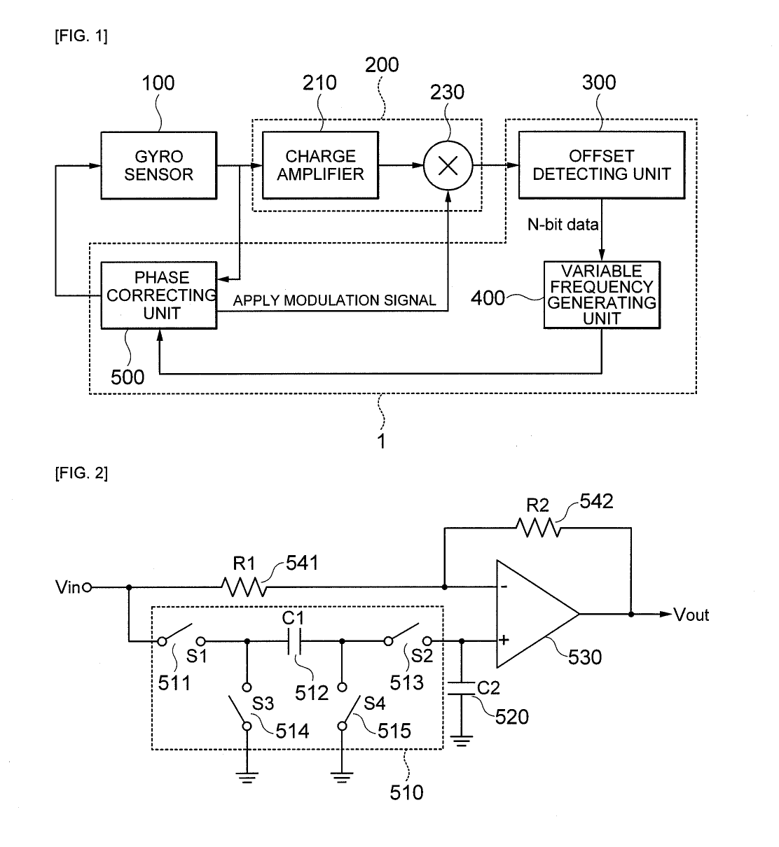

FIG. 1 is a block diagram schematically showing a gyro sensor system including a circuit for correcting a phase error of a gyro sensor in accordance with one embodiment of the present invention and FIG. 2 is a circuit diagram schematically showing a phase correcting unit in one example of the circuit for correcting the phase error of the gyro sensor as shown in FIG. 1.

Referring to FIG. 1, the circuit 1 for correcting a phase error of a gyro sensor in accordance with one embodiment of the present invention may be formed of an offset detecting unit 300, a variable frequency generating unit 400 and a phase correcting unit 500.

At this time, the offset detecting unit 300 detects an offset due to a phase error included in a gyro output signal to be outputted by being modulated from an output of the gyro sensor 100. The sensor output signal of the gyro sensor 100 includes a driving signal component and a gyro signal component. At this time, in general, since the driving signal component is stronger than the gyro signal component, the driving signal component included in the sensor output signal is removed in order to know an exact output result of the gyro sensor. For example, as a signal to modulate the sensor output signal, the driving signal component included in the sensor output signal can be removed by applying the driving signal supplied to the gyro sensor 100. However, since the phase error exists in each sensor electrode, although the driving signal component included in the sensor output signal is removed by using a construction signal supplied to the gyro sensor 100, the driving component included in the sensor output signal is not accurately and completely removed due to the phase error, thereby generating the offset. Such offset makes the signal distorted due to the phase error remaining during the driving signal component removing process.

In the present embodiment, the offset due to the phase error is detected and the phase of the driving signal to be applied as the demodulation signal by an amount corresponding to the detected result is corrected. At this time, it is required that the offset due to the phase error is detected in the offset detecting unit 300. If the construction signal component included in the sensor output of the gyro sensor 100 is filtered by using an original driving signal after being modulated, it has a value of 0 ideally, but since it does not have the phase difference of 90 degrees accurately with reference to the original driving signal due to the phase error of the sensor electrode, this result is represented as the DC offset. Such offset is detected. For example, the offset detecting unit 300 can detect the offset according to the phase error for each sensor electrode by being provided with a differential amplifier.

The variable frequency generating unit 400 of FIG. 1 generates a switching frequency varied according to the result detected in the offset detecting unit 300. The generated variable switching frequency is utilized as a sampling frequency in a switched capacitor 510 of the phase correcting unit 500. For example, the variable frequency generating unit 400 can generate the switching frequency signal varied by comparing the offset signal detected in the offset detecting unit 300 with a reference signal. At this time, the generated variable switching frequency can correct the phase in the phase correcting circuit by tuning an equivalent resistance value of the switched capacitor 510 of the phase correcting unit 500.

Thereafter, the phase correcting unit 500 of FIG. 1 will be reviewed. The phase correcting unit 500 utilizes the driving signal as the demodulation signal for modulating the gyro output signal from the output of the gyro sensor 100. Since the sensor output signal of the gyro sensor 100 includes the driving signal component and the gyro signal component and the gyro signal component is stronger than the driving signal component, the gyro sensor driving signal can be utilized as the demodulation signal to separate the gyro output signal from the output of the gyro sensor 100. But, since the driving signal includes the phase error according to the characteristics for each sensor electrode during passing the gyro sensor 100, in case when the driving signal supplied to the gyro sensor 100 and the same signal are utilized as the demodulation signal, the remaining driving signal component without being removed according to the phase error and the offset due to this makes the signal distorted. Accordingly, in order to be used as a demodulation signal for separating the driving signal from the gyro output signal, the correction corresponding to the phase error must be performed.

In the embodiments of the present invention, the driving signal corrected in the phase according to the signal transmission characteristic of the switched capacitor 510 is supplied as the demodulation signal. In general, in order for the phase correction, for example, a phase shifter may be utilized. An example of a method for controlling the frequency response characteristics through a trimming of a device value of the phase shifter to convert the phase may be a method to construct a variable resistor with a plurality of resistor devices or to connect a plurality of capacitor in parallel. For example, the phase shifter may convert the phase by changing an RC value between a resistor R connected a non-inverting terminal and an input signal and a capacitor C connected between the non-inverting terminal and a ground. At this time, in case when the resistor R is utilized as a variable resistor, since an amount of change is generated in the resistor value according to the temperature, there occurs a problem that the phase shifter has a different phase change value according to the temperature. In case when the resistor R is constructed with a variable resistor formed of a plurality of resistors, there are problems of temperature as well as the increment of size. In order for varying the capacitor C, the capacitor may be formed of a plurality of capacitors connected to each other in parallel. At this time, there is a problem that the size of products increases.

In the embodiments, the phase correcting unit 500 of FIG. 1 is provided with the switched capacitor 510. The switching frequency is a sampling frequency of the switched capacitor 510; the switched capacitor 510 has the signal transmission characteristic in accordance with the varied switching frequency; and, accordingly, it plays a role of the varied resistor. That is, the phase correcting unit 500 includes the switched capacitor 510 switched according to the switching frequency by employing the switching frequency generated in the variable frequency generating unit 400 as the sampling frequency and the driving signal corrected in the phase according to the signal transmission of the switched capacitor 510 according to the switching frequency is supplied as the demodulation signal.

On the other hands, in FIG. 1, there are shown that the phase correcting unit 500 in FIG. 1 receives the sensor output signal of the gyro sensor 100 and the gyro sensor driving signal is applied to the gyro sensor 100. The phase error correcting circuit 1 in accordance with the first embodiment of the present invention is additionally provided with a driving signal applying unit (not shown) for applying the driving signal to the gyro sensor 100 differently from as shown in FIG. 1. As shown in FIG. 1, the driving signal applying unit (not shown) for applying the driving signal to the gyro sensor 100 may be integrated with the phase correcting unit 500 of the present invention as one body. For example, in case when the driving signal applying unit (not shown) is additionally included, the phase correcting unit 500 may correct the phase by receiving the driving signal outputted from the driving signal applying unit to output it as the demodulation signal.

Referring to FIG. 2, the phase correcting unit 500 will be described further.

Referring to FIG. 2, as one example, the phase correcting unit 500 may include the switched capacitor 510, a ground capacitor 520 and an amplifier 530.

At this time, the switched capacitor 510 receives the gyro sensor driving signal to transmit it. The signal transmission characteristic of the switched capacitor 510 are varied according to the switching frequency generated in the variable frequency generating unit 400. Accordingly, the switched capacitor 510 may play a role of a resistor varied according to the switching frequency.

Thereafter, referring to FIG. 2, the ground capacitor 520 is connected between an output terminal of the switched capacitor 510 and a ground. At this time, the ground capacitor 520 has a fixed value.

And, the amplifier 530 of FIG. 2 changes the phase with the values of the switched capacitor 510 and the ground capacitor 520 by receiving the gyro sensor driving signal to output the value having the corrected phase. At this time, the phase converted output may be directly applied as the demodulation signal for separating the gyro output signal from the output signal of the gyro sensor 100 or applied by generating a pulse wave.

In the embodiments of the present invention, the amplifier 530 changes the phase to allow the inputted gyro sensor driving signal to have the corrected phase value according to the varied signal transmission characteristic value of the switched capacitor 510 and the value of the ground capacitor 520 in accordance with the switching frequency generated in the variable frequency generating unit 400 to output and the output signal may be applied as the demodulation signal.

Referring to FIG. 2, reviewing in detail, as one example, a resistor R2 542 may be provided on a path fed back from an output terminal of the amplifier 530 to an inverting input terminal. And also, at the inverting input terminal of the amplifier 530, a resistor R1 541 is connected for transmitting the gyro sensor driving signal by receiving the gyro sensor driving signal through the resistor R2 542. And, at a non-inverting input terminal of the amplifier 530, the switched capacitor 510 and the ground capacitor 520 are connected.

And also, referring to FIG. 2, another embodiment of the present invention will be reviewed.

As one example, the switched capacitor 510 is connected between a first switch 511 and a second switch 512 and a first switch 511 and the second switch 512; and may be provided with a first capacitor 513 for charging and discharging according to the switching operations of the first and second switches, a third switch 514 and a fourth switch 515. For example, the switched capacitor 510 may be realized with a negative transresistance or a positive transresistance.

In FIG. 2, the first switch 511 performs a switching operation and transmits the gyro sensor driving signal received from the input terminal to the first capacitor 513. The second switch 512 performs a switching operation and outputs a signal transmitted from the first capacitor 513 through an output terminal of the switched capacitor 510. For example, the charging and discharging are alternately performed in the first capacitor 513 connected between the first switch 511 and the second switch 512 through alternately switching the first switch 511 and the second switch 512. And also, the third switch 514 is connected between a connecting node of the first capacitor 512 and a ground. And, the fourth switch 515 is connected between the first capacitor 513 and a connecting node of the second switch 512.

At this time, as another example, according to the switching frequency generated in the variable frequency generating unit 400, a group of the first and third switches and a group of the second and fourth switches may be alternately switched. Reviewing the operations, when the first and the fourth switches 511 and 515 are turned on, the second and the third switches 512 and 514 are turned off; and when the first and the fourth switches 511 and 514 are turned off, the second and the third switches 512 and 514 are turned on. That is, according to the switching of the switched capacitor 510, the negative transreistance is formed. At this time, the value of the transresistance R_{T} is equal to −T/C1. The T is a period of the switching frequency and the C1 is the value of the first capacitor 513.

In another example, the first and second switch group and the third and fourth switch group may be alternately switched. At this time, the positive transresistance is formed and the value of the transresistance becomes T/C1.

On the other hands, although not shown, the switched capacitor 510 may be a parallel switched capacitor in a shape of “T”. At this time, the first switch is connected between an input terminal and the second switch and the second switch is connected between the first switch and the output terminal. The capacitor is connected between the first switch, the connection node of the second switch and the ground. The signal inputted from the input terminal is stored in the capacitor during the on-operation of the first switch and the off-operation of the second switch and the signal stored the capacitor during the off-operation of the first switch and the on-operation of the second switch may be transmitted to the output terminal.

In case of a method for correcting the phase through a plurality of capacitors or a plurality of resistor arrays, in order to have a desired tuning range wide, since a design is configured in a shape where capacitors or resistors are arranged as many, it has a shortcoming in a view of size. And also, it can adjust the phase only in the specific values and the ranges thereof defined by the design.

Whereas, in the present invention, the phase value can be controlled through the frequency change by implementing an equivalent resistor using the structure of the switched capacitor 510. And also, whereas it has a phase error according to the temperature change since the resistor is changed according to the temperature, the almost uniform phase result can be generated for the temperature by having the variable resistance value using the capacitor.

Thereafter, a gyro sensor system in accordance with second embodiment of the present invention will be described in detail with reference to the drawings.

At this time, the examples of the circuit for correcting the phase error of the gyro sensor in accordance with the above-described first embodiment as well as FIG. 1 and FIG. 2 will be referred; and, accordingly, the repeated explanations may be omitted.

FIG. 1 is a block diagram schematically showing a gyro sensor system including a circuit for correcting a phase error of a gyro sensor in accordance with one embodiment of the present invention.

Referring to FIG. 1, the gyro sensor system in accordance with one example includes a signal processing unit 200, an offset detecting unit 300, a variable frequency generating unit 400 and a phase correcting unit 500.

By receiving the driving signal of the gyro sensor 100 in FIG. 1, the sensor output signal in accordance with the movement of an object is outputted through the sensor electrode. The sensor output signal outputted from the gyro sensor has the phase substantially delayed by 90°; and, further, the phase is additionally delayed by an amount of phase error of the sensor electrode. For example, at this time, the driving signal of the gyro sensor can be applied by compensating the phase substantially delayed 90° at the sensor output signal; and, in order for solving the offset due to the phase error of the sensor electrode, similar to the embodiments of the present invention, the driving signal can be supplied as the demodulation signal by correcting the phase by an amount corresponding to the offset.

And also, as one example, the gyro sensor 100 may be a piezoelectric type or an electrostatic vibration type gyro sensor.

The signal processing unit 200 separates the gyro signal component included in the sensor output signal by receiving the sensor output signal from the gyro sensor 100 to output it as the gyro output signal. The sensor output signal of the gyro sensor 100 includes the driving signal component and the gyro signal component. Since the driving signal component is stronger than the gyro signal component, in order to known the output result of the accurate gyro sensor 100, the driving signal component included in the sensor output signal in the signal processing unit 200 must be removed. In order for this, the driving signal is utilized as the demodulation signal. At this time, since the offset due to the phase error in the electrode of the gyro sensor 100 is generated, in order to solve this, the demodulation signal corrected in the phase of the driving signal by an amount corresponding to the phase error may be applied.

And also, referring to FIG. 1, the signal processing unit 200 will be described in detail. As one example, the signal processing unit 200 may include a charge voltage converting unit 210 and an analog signal processing unit 230.

At this time, the charge voltage converting unit 210 receives the sensor output signal from the gyro sensor 100 and converts it into a voltage signal with a charge amplifier.

Thereafter, the analog signal processing unit 230 can output the gyro output signal by receiving the output signal converted from the charge voltage converting unit 210, separating the driving signal component and the gyro signal component included therein by using the demodulation signal applied from the phase correcting unit 500 and removing the separated driving signal component.

At this time, although not shown, in accordance with another example, the analog signal processing unit 230 can include a demodulator and a low pass filter. The demodulator can separate the driving signal component and the gyro signal component using the demodulation signal by receiving the output signal of the charge voltage converting unit 210. The low pass filter can remove the driving signal component separated in the demodulator.

The separation process of the driving signal component and the gyro signal component included in the sensor output signal will be reviewed by using the driving signal as the demodulation signal. The sensor output signal of the gyro sensor 100 applied to the demodulator as an element of the analog signal processing unit 230 is mixed with the driving signal component and the gyro signal component; and, in general, the phase of the gyro signal component is in advance 90° in comparison with that of the driving signal component. At this time, if the pulse signal having the same phase of the gyro signal component is applied as the demodulation signal and the driving signal component is modulated and averaged by the demodulation signal, it can be averaged by a reference voltage Vref. Whereas, the gyro signal component is modulated by the demodulation signal; and, if it is averaged, it has a specific value slightly separated from the reference voltage Vref. At this time, the driving signal component can be removed through the low pass filter as one element of the analog signal processing unit 230. At this time, the demodulation signal has a phase in advance 90° in comparison with the driving signal component included in the sensor output signal. However, in this case, since the offset according to the phase error of the electrode of the gyro sensor 100 is generated, the signal used as the demodulation signal is used by correcting the phase of the gyro sensor driving signal by an amount corresponding to the phase error.

And also, the offset detecting unit 300 of FIG. 1 detects the offset due to the phase error included in the gyro output signal outputted from the signal processing unit 200. The driving signal component included in the sensor output signal is not completely removed through a simple demodulation process due to the phase error generated according to the sensor electrode and it generates the offset. Since the offset can distort the signal to be obtained, the phase error causing the offset must be removed. In the present example, the offset due to the phase error is detected and the phase error is removed by correcting the phase of the driving signal to be applied as the demodulation signal by an amount corresponding to the detected result.

Thereafter, the variable frequency generating unit 400 of FIG. 1 generates the switching frequency varied according to the result detected in the offset detecting unit 300.

Thereafter, the phase correcting unit 500 of FIG. 1 will be reviewed. The phase correcting unit 500 receives the sensor output signal of the gyro sensor 100 and supplies a feedback driving signal to the gyro sensor 100 by converting the phase thereof. The element for taking charge of applying such driving signal may be integrated as one body with the element for performing the function of applying the demodulation signal to be explained as follow as shown in FIG. 1. Or, differently from as shown in FIG. 1, the driving signal applying unit (not shown) for taking charge of applying the driving signal and a demodulation signal applying unit (not shown) are additionally constructed and they may be included in the phase correcting unit 500 of the present embodiment together with.

The phase correcting unit 500 of the present example includes the switched capacitor switched according to the switching frequency generated in the variable frequency generating unit 400. The phase correcting unit can supply the driving signal corrected according to the signal transmission characteristic of the switched capacitor 510 to the signal processing unit 200 as the demodulation signal to modulate the gyro output signal in the signal processing unit 200.

Also, according to one example, referring to FIG. 2, the phase correcting unit 500 may include the switched capacitor 510, the ground capacitor and the amplifier 530. FIG. 2 does not show the phase correcting unit 500 for being in charge of applying the driving signal to supply the feedback driving signal to the gyro sensor 100 by converting the phase thereof with receiving the sensor output signal, but it shows the constructions to generate the demodulation signal for correcting the gyro driving signal in phase corresponding to the phase error.

At this time, the switched capacitor 510 receives the gyro sensor driving signal to transmit and has the signal transmission characteristic varied according to the switching frequency. At this time, the switched capacitor 510 forms the tansresistance to perform a role of a resistor.

The ground capacitor 520 is connected between the output terminal of the switched capacitor 510 and the ground.

Also, the amplifier 530 of FIG. 2 receives the gyro sensor driving signal and converts its phase to output. At this time, the amplifier 530 changes the phase of the sensor output signal so as to have the phase values corrected according to the signal transmission characteristic of the switched capacitor 510 varied according to the switching frequency and the value of the ground capacitor to thereby output the changed result.

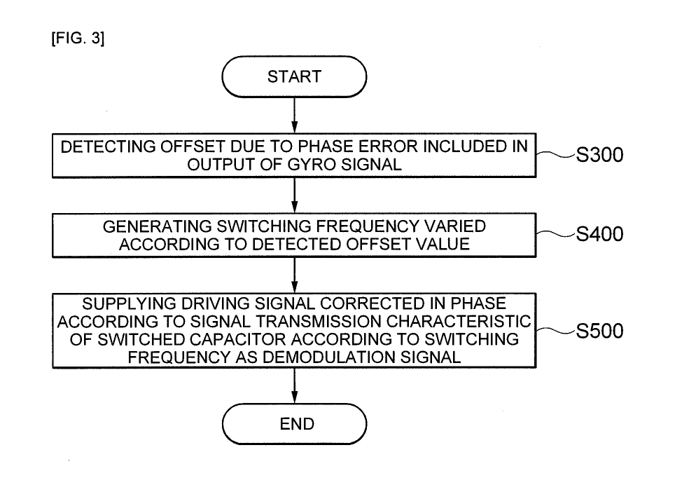

Thereafter, a method for correcting a phase error of a gyro sensor in accordance with a third embodiment of the present invention will be described in detail with reference to the drawings. At this time, the following FIG. 3 to FIG. 5 as well as the examples of the circuit for correcting the phase error of the gyro sensor in accordance with the above-described first embodiment and the gyro sensor system and FIGS.1 and 2 may be referred; and accordingly, the duplicated explanations may be omitted.

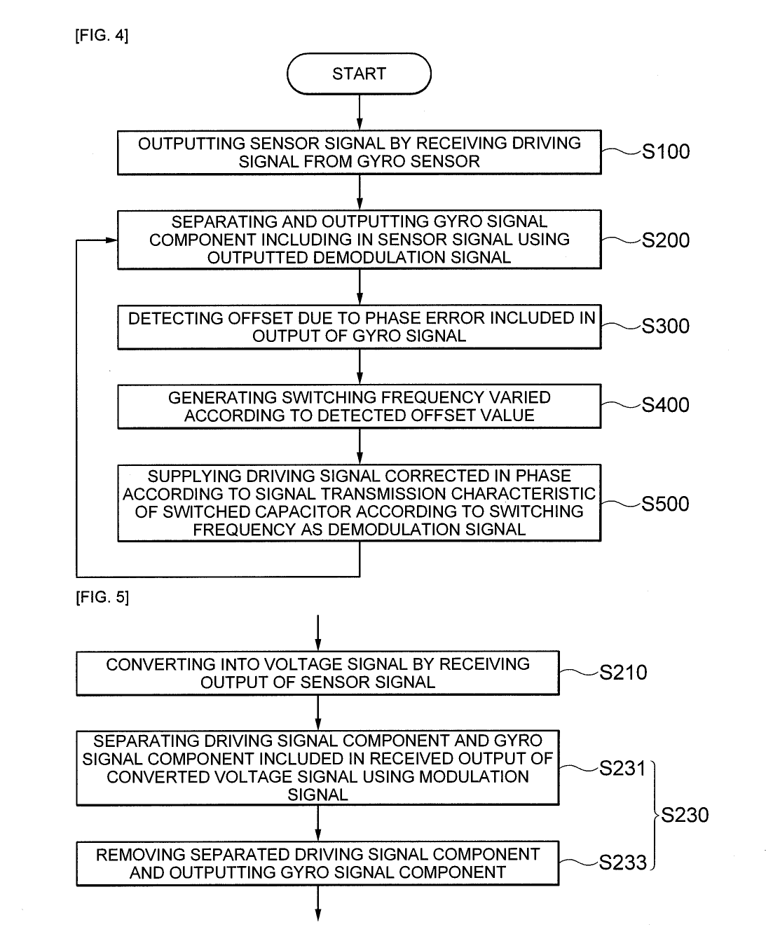

FIG. 3 is a flow chart schematically showing a method for correcting a phase error of a gyro sensor in accordance with one embodiment of the present invention, FIG. 4 is a flow chart schematically showing a method for correcting a phase error of a gyro sensor in accordance with another embodiment of the present invention and FIG. 5 is a flow chart schematically showing a method for correcting a phase error of a gyro sensor in accordance with still another embodiment of the present invention.

Referring to FIG. 3, the method for correcting the phase error of the gyro sensor in accordance with one example includes an offset step (S300), a switching frequency generating step (S400) and a demodulation signal supplying step (S500).

At first, in the offset detecting step (S300) of FIG. 3, the offset due to the phase error included in the gyro output signal outputted by being modulated from the output of the gyro sensor 100 is detected.

Thereafter, in the switching frequency generating step (S400), the switching frequency varied according to the result detected in the offset detecting step (S300) is generated.

Thereafter, in the demodulation signal supplying step (S500) of FIG. 3, the gyro sensor driving signal is supplied as the demodulation signal for modulating the gyro output signal from the output of the gyro sensor 100. At this time, the driving signal corrected in phase according to the signal transmission characteristic of the switched capacitor 510 switched according to the switching frequency (S500).

Reviewing one example with reference to FIG. 4, the method for correcting the phase error of the gyro sensor can further include a sensor output signal output step (S100) and a gyro output signal output step (S200).

In the output signal output step (S100) of FIG. 4, the sensor output signal according to the movement of the object is outputted through the sensor electrode by receiving the driving signal in the gyro sensor 100.

Thereafter, in the gyro output signal output step (S200), the gyro signal component included in the sensor output signal is separated by receiving the output signal of the sensor electrode using the demodulation signal supplied in the above-described demodulation signal supplying step (S500) to output as the gyro output signal.

At this time, although not shown, reviewing one example with reference to FIG. 1, in the offset detecting step (S300), the offset due to the phase error included in the gyro output signal outputted in the gyro output signal output step (S200) can be detected.

At this time, referring to FIG. 5, as one example, the above-described gyro output signal output step (S200 of FIG. 4) can include a step (S210) for converting into a voltage signal by receiving the sensor output signal of the sensor electrode and a step (S230) for outputting the gyro output signal by separating the driving signal component and the gyro signal component included in the output signal by receiving the output of the converted voltage signal and removing the separated driving signal component.

In accordance with the embodiments of the present invention, the distortion of the offset according to the phase error can be prevented by applying as the demodulation signal for modulating the gyro output signal from the output of the gyro sensor by generating the phase corrected demodulation signal by detecting the change of the phase error included in the gyro output signal outputted by being modulated from the output of the gyro sensor.

And also, the phase value can be controlled through the frequency change by realizing the equivalent resistor by using the switched capacitor in accordance with the embodiments of the present invention; and also, there is an advantage capable of representing an almost constant phase result to the temperature by using the capacitor without the resistor to generate the phase error according to the temperature change.

It is obvious that various effects without being directly mentioned according to various embodiments of the present invention can be derived by those skilled in the art from various constructions in accordance with the embodiments of the present invention.

Embodiments of the invention have been discussed above with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention.

What is claimed is:

1. A circuit for correcting a phase error of a gyro sensor, comprising:
an offset detecting unit for detecting an offset due to the phase error included in a gyro output signal outputted by being demodulated from an output of the gyro sensor;
a variable frequency generating unit for generating a switching frequency varied according to the result detected in the offset detecting unit; and
a phase correcting unit including a switched capacitor switched according to the switching frequency generated in the variable frequency generating unit and supplying a gyro sensor driving signal from the output of the gyro sensor as a demodulation signal to demodulate the gyro output signal, wherein the gyro sensor driving signal being supplied as the demodulation signal is corrected in phase according to a signal transmission characteristic of the switched capacitor.

2. The circuit for correcting a phase error of a gyro sensor according to claim 1, wherein the phase correcting unit includes:
the switched capacitor for playing a role of a resistor varied according to the switching frequency, wherein the switched capacitor receives and transmits the gyro sensor driving signal;
a ground capacitor connected between an output terminal of the switched capacitor and a ground; and
an amplifier for receiving the gyro sensor driving signal, outputting the gyro sensor driving signal corrected in phase according to the value of the ground capacitor and a signal transmission characteristic value of the switched capacitor being varied according to the switching frequency and supplying the gyro sensor driving signal corrected in phase as the demodulation signal.

3. The circuit for correcting a phase error of a gyro sensor according to claim 2, wherein a resistor R2 is formed on a path which is fed back from an output terminal of the amplifier to an inverted input terminal of the amplifier, a resistor R1 is connected to the inverted input terminal of the amplifier to receive the gyro sensor driving signal and to the gyro sensor driving signal transmit through the resistor R2, and the switched capacitor and the ground capacitor are connected to a non-inverted input terminal of the amplifier.

4. The circuit for correcting a phase error of a gyro sensor according to claim 2, wherein the switched capacitor includes:
a first switch for transmitting the gyro sensor driving signal received from an input terminal of the switched capacitor with performing a switching operation;
a second switch for outputting the signal received from a first capacitor through an output terminal of the switched capacitor with performing a switching operation;
the first capacitor connected between the first switch and the second switch for charging and discharging according to the switching operations of the first and second switches;
a third switch connected between a connection node of the first switch and the first capacitor and the ground; and
a fourth switch connected between a connection node of the first capacitor and the second switch and the ground.

5. The circuit for correcting a phase error of a gyro sensor according to claim 4, wherein a group of the first and third switches and a group of the second and fourth switches are alternately switched according to the switching frequency;
the second and fourth switches are turned off when the first and third switches are turned on; and
the second and fourth switches are turned on when the first and third switches are turned off.

6. A gyro sensor system, comprising:
a gyro sensor for outputting a sensor output signal according to a movement of an object through a sensor electrode by receiving a driving signal;
a signal processing unit for receiving the sensor output signal from the gyro sensor, separating a gyro signal component included in the sensor output signal and outputting as a gyro output signal;
an offset detecting unit for detecting an offset due to a phase error included in the gyro output signal outputted from the signal processing unit;
a variable frequency generating unit for generating a switching frequency varied according to the result detected in the offset detecting unit; and
a phase correcting unit for receiving the sensor output signal of the gyro sensor, converting a phase thereof and supplying a gyro sensor driving signal to the gyro sensor by feedback, wherein the phase correcting unit includes a switched capacitor switched according to a switching frequency generated in the variable frequency generating unit and supplies the gyro sensor driving signal corrected the phase thereof according to a signal transmission characteristic of the switched capacitor as a demodulation signal for demodulating the gyro output signal in the signal processing unit.

7. The gyro sensor system according to claim 6, wherein the phase correcting unit includes:
the switched capacitor for playing a role of a resistor varied according to the switching frequency, wherein the gyro sensor driving signal is inputted to and transmitted from the switched capacitor;
a ground capacitor connected between an output terminal of the switched capacitor and a ground; and
an amplifier for receiving the gyro sensor driving signal, outputting the gyro sensor driving signal corrected in phase according to the value of the ground capacitor and a signal transmission characteristic value of the switched capacitor being varied according to the switching frequency and supplying the gyro sensor driving signal corrected in phase as the demodulation signal.

8. The gyro sensor system according to claim 6, wherein the signal processing unit includes:
a charge voltage converting unit for receiving the sensor output signal from the gyro sensor to convert into a voltage signal; and
an analog signal processing unit for receiving an output signal converted from the charge voltage converting unit, separating a driving signal component and a gyro signal component included therein by using the demodulation signal applied from the phase correcting unit, and outputting the gyro output signal by removing the separated driving signal component.

9. The gyro sensor system according to claim 8, wherein the analog signal processing unit includes:
a demodulator for receiving the output signal of the charge voltage converting unit, and separating the driving signal component and the gyro signal component by using the demodulation signal; and
a low pass filter for removing the driving signal component separated from the demodulator.

10. The gyro sensor system according to claim 6, wherein the gyro sensor is a piezoelectric type or an electrostatic vibration gyro sensor.

11. The gyro sensor system according to claim 7, wherein the gyro sensor is a piezoelectric type or an electrostatic vibration gyro sensor.

12. The gyro sensor system according to claim 8, wherein the gyro sensor is a piezoelectric type or an electrostatic vibration gyro sensor.

13. The gyro sensor system according to claim 9, wherein the gyro sensor is a piezoelectric type or an electrostatic vibration gyro sensor.

14. A method for correcting a phase error of a gyro sensor, comprising:
detecting an offset due to a phase error included in a gyro output signal outputted by being demodulated from an output of the gyro sensor;
generating a switching frequency varied according to a result detected in detecting the offset; and
supplying a gyro sensor driving signal from the output of the gyro sensor as a demodulation signal to demodulate the gyro output signal, wherein the gyro sensor driving signal being supplied as the demodulation signal is corrected in phase according to a signal transmission characteristics of a switched capacitor being switched according to the switching frequency.

15. The method for correcting a phase error of a gyro sensor according to claim 14, further comprising:
receiving a driving signal in the gyro sensor and outputting a sensor output signal according to a movement of an object through a sensor electrode; and
separating a gyro signal component included in the outputted sensor output signal using the demodulation signal supplied in the step of supplying the gyro sensor driving signal, and outputting the gyro signal component as the gyro output signal,
wherein, in detecting the offset, the offset due to the phase error included in the gyro output signal outputted in outputting the gyro signal component is detected.

16. The method for correcting a phase error of a gyro sensor according to claim 15, wherein outputting the gyro signal component includes:
receiving the sensor output signal of the sensor electrode and converting into a voltage signal; and
separating a driving signal component and the gyro signal component included in the output signal converted into voltage signal and outputted using the demodulation signal to remove the separated driving signal component and outputting the gyro signal component as the gyro output signal.
